(19) United States
(12) Patent Application Publication
(10) Pub. No.: US 2012/0168431 A1
(43) Pub. Date: Jul. 5, 2012

(54) HEATING ELEMENT

(75) Inventors: Mats Sundberg, Västerås (SE); Erik Ström, Vasteras (SE)

(73) Assignee: Sandvik Intellectual Property AB, Sandviken (SE)

(21) Appl. No.: 13/256,292

(22) PCT Filed: May 3, 2010
(86) PCT No.: PCT/SE2010/050481

§ 371 Date: Mar. 5, 2012

(30) Foreign Application Priority Data
May 5, 2009 (SE) 0900607-3

(51) Int. Cl. H05B 3/14; C04B 35/58; H05B 3/62

(52) U.S. Cl. 219/553; 373/117

(57) ABSTRACT

A heating element for use in industrial furnaces, which enables the use of a higher voltage over the element. The heating element includes a heating zone made of a molybdenum disilicide based material including 48-75% by volume of a non-conducting compound and two terminals made of a molybdenum disilicide based material including up to 25% by volume of a non-conducting compound.

The present disclosure relates in general to a heating element of molybdenum disilicide type comprising at least one heating zone and two terminals. More specifically, it relates to a heating element comprising a heating zone made of a molybdenum disilicide based material.

### BACKGROUND

Heating elements of molybdenum disilicide materials are widely used in industrial furnaces operating at relatively high temperatures, such as above 1000° C., due to their ability to withstand oxidation at such high temperatures. The oxidation resistance is a result of the formation of a thin and adhesive protective layer of silica glass on the surface.

An example of a heating element of this type is illustrated in FIG. 1. The heating element 1 is a two shank element and comprises a heating zone 3 having a diameter d and a length Lₑ, and two terminals 2 having a diameter D and a length Lᵤ, said terminals provided in each end of the heating zone 3. The two shanks are essentially parallel and arranged a distance a from each other.

In use the heating zone is located inside a furnace and the terminals run through the furnace wall and are electrically connected on the outside of the furnace. The terminals are normally made of the same material as the heating zone, but have a larger diameter than the heating zone in order to reduce the current density and thus the temperature.

In a heating element of typical dimensions, 5-10% of the power provided to the heating element is dissipated as heat in the terminals. This heat does not contribute to the efficiency of the heating element. On the contrary, a profound heating of the terminals may for example cause problems with the connection of the terminals to the leads.

Examples of applications wherein this type of heating elements may be used include but is not limited to industrial furnaces for heat treatment, forging, sintering, glass melting and refining. This type of heating elements may also be used in radiant tubes and in laboratory furnaces.

One example of a previously known heating element is disclosed in U.S. Pat. No. 3,607,475. The heating element is formed of a powder metallurgical composition of molybdenum disilicide and a glass phase rich in SiO₂. The element has a U-shaped heating zone and two terminals, wherein the terminals are thicker than the heating zone.

Another example of a heating element is disclosed in U.S. Pat. No. 6,211,496. The heating element is made of a molybdenum disilicide based ceramic composite consisting essentially of molybdenum disilicide grains having a network structure and a secondary phase consisting of at least one material selected from the group consisting of a silicon bearing oxide and a glass. The secondary phase is distributed within said network structure in a net-like form along the boundaries of the molybdenum disilicide grains. The secondary phase is present in an amount of 20 to 45% by volume.

JP 2007-128796 discloses a heating element which is said to have high pest resistance. The terminals are made of a molybdenum disilicide material comprising 30-60% by volume of oxide phase and the heating zone is made of a molybdenum disilicide material comprising 5-25% by volume of oxide phase.

For sake of economy and environment, it is desirable to be able to lower the energy consumption when utilizing an industrial furnace without having to lower the operation temperature of the furnace. It is therefore important to be able to minimize loss of power in the element.

### SUMMARY OF THE INVENTION

The object of the invention is to provide a heating element which is suitable for use in an industrial furnace and which may be used with high voltage and low current. It is a further object of the invention to provide a heating element which enables energy efficient operation of an industrial furnace.

These objects are achieved by the subject-matter of the independent claim 1. Preferred embodiments are given in the dependent claims.

The heating element according to the present invention comprises at least one heating zone and two terminals. At least a portion of the heating zone is made of a first molybdenum disilicide based material, the first molybdenum disilicide based material comprising 48-75% by volume of a non-conducting compound. At least a portion of at least one of the two terminals is made of a second molybdenum disilicide based material, said second molybdenum disilicide based material comprising up to 25% by volume of a non-conducting compound.

The different non-conducting compound contents of the first and second molybdenum disilicide based materials will render the two materials different resistivity. The resistivity of the first molybdenum disilicide based material will be substantially higher than the resistivity of the second molybdenum disilicide based material. Thereby, the resistivity of the heating zone of the heating element will be substantially higher than the resistivity of the terminals. This will in turn lead to a higher generated power and thus temperature in the heating zone compared to in the terminals.

The heating element according to the invention enables a more efficient usage of the provided energy.

A non-conducting compound should for the purpose of this application be considered as a compound that has a resistivity above 10³ Ωm in the temperature range 1000-1600° C. According to one embodiment of the invention the non-conducting compound is an oxide phase, i.e. SiO₂ or Al₂O₃. Further alternatives include, but are not limited to, silicon carbides, in particular SiC, and silicon nitrides.

As appreciated by the person skilled in the art a portion of the molybdenum in the molybdenum disilicide based materials can be substituted with primarily tungsten and rhenium, and to lower extent chromium. Such substitutions are in the art done to tailor mechanical and/or corrosion properties and will have limited effect on the electrical properties. It should be understood that the term “molybdenum disilicide based material” used throughout the application include such known variations of heating elements based on molybdenum disilicide materials with regards to substitution with tungsten, rhenium and chromium.

Unavoidable impurities will always be present in the first and second molybdenum disilicide based material.

The heating zone may for example be in the form of a rod, suitably with a diameter of 2-15 mm, preferably approximately 3-12 mm. The heating zone may be straight or bended, for example in a U-form, depending on the intended use of the heating element. The heating element may also be a helically shaped heating element. The cross section of the rod may typically be circular, but may depending on the application have other geometrical shapes, elliptical or rectangular, for example.

According to a preferred embodiment, the heating zone may have a first and a second end. A first terminal is provided in the first end of the heating zone and a second terminal is provided in the second end of the heating zone.

The heating zone may also comprise a plurality of heating zone sections wherein at least one is made of the first molybdenum disilicide material. According to one alternative embodiment, the heating zone comprises a plurality of heating zone sections wherein at least the heating zone sections connected to the respective terminal are made of the first molybdenum disilicide based material.

The terminals may be in the form of rods and may have the same diameter as the heating zone, but may also be thicker or thinner than the heating zone.

### BRIEF DESCRIPTION OF THE DRAWINGS

FIG. 1 Illustrates a U-shaped two-shank heating element according to the invention comprising a heating zone and two terminals.

FIG. 2 Illustrates a U-shaped two shank heating element according to an alternative embodiment of the invention wherein the heating zone comprises a plurality of sections.

FIG. 3 illustrates a four shank heating element according to one embodiment of the invention.

FIG. 4 illustrates a helically shaped heating zone of a heating element according to the present invention.

### DETAILED DESCRIPTION

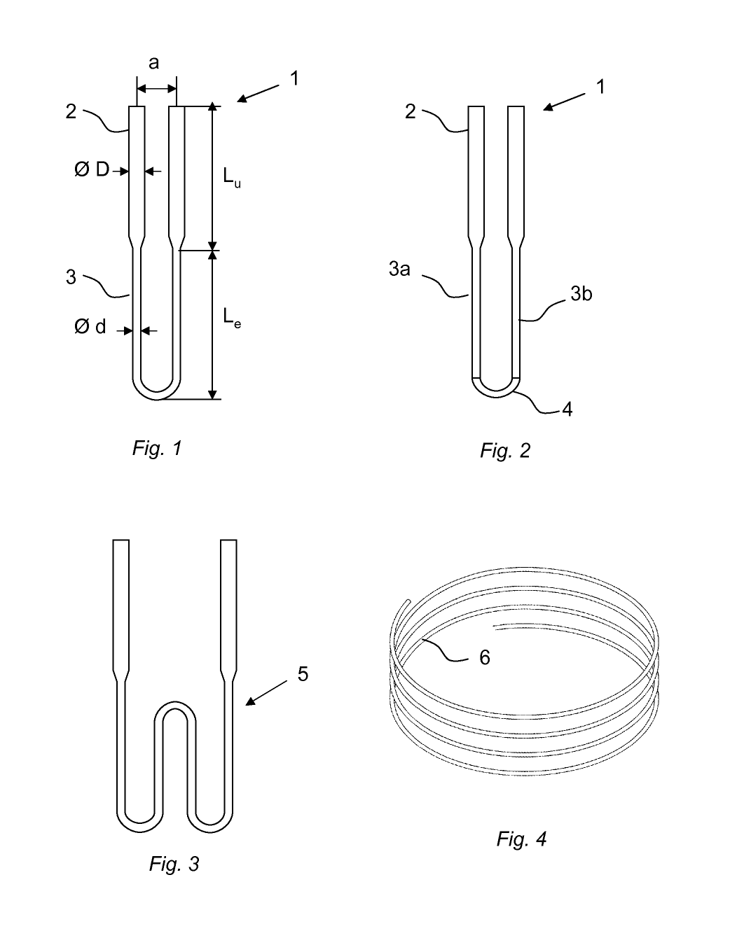

FIG. 1 illustrates one example of a heating element 1 comprising a heating zone 3 and two terminals 2 in each end of the heating zone 3. The illustrated heating element 1 is a two shank U-shaped heating element. The heating element according to the invention may however have other shapes, such as a four shank heating element, a helix shaped heating element or a heating element having a straight heating zone. The heating element may also have more than one heating zone and more than two terminals. Furthermore, the heating zone may be divided into a plurality of heating zone sections.

In FIG. 1, the terminals 2 each have a diameter D which is greater than the diameter d of the heating zone. It should however be noted that the terminal 2 may have essentially the same diameter as the heating zone 3.

As disclosed above, molybdenum disilicide based materials comprising oxide phase are previously known for use as heating elements. Also other non-conducting compound, such as silicon carbide or silicon nitrides can be envisaged. In the following the present invention will be illustrated, as a non-limiting example, with oxide phase as the non-conducting compound, representing a preferred embodiment of the invention. The oxide phase is homogenously distributed in the material and also present on the surface of the heating element as a result of high temperature oxidation. However, in the purpose of the present disclosure a molybdenum disilicide based material comprising a certain amount of oxide phase should be interpreted as the amount of oxide phase being distributed in the bulk material. The oxide phase will be distributed homogenously in the bulk material along the boundaries of the molybdenum disilicide grains. These molybdenum disilicide based materials may also be described as cermets essentially consisting of MoSi₂ and an oxide phase.

The oxide phase of the first molybdenum disilicide based material may be SiO₂-based, Al₂O₃-based or a compound comprising essentially SiO₂ and Al₂O₃. The oxide phase may also comprise impurity elements as a result of the raw materials used for producing the elements.

A least a portion of the heating zone of the heating element according to the invention is made of a first molybdenum disilicide material, said first material comprising 48-75% by volume of oxide phase. According to a preferred embodiment, the content of oxide phase in the first molybdenum disilicide material is 50-68% by volume, even more preferably 52-63% by volume.

The relatively high oxide content of the first molybdenum disilicide based material used in the heating zone ensures that the material has a high resistivity, but is sufficiently low to ensure that the material is conductive.

According to a preferred embodiment the first molybdenum disilicide based material comprises an oxide phase based on mullite. Mullite has the general formula 3 Al₂O₃.2SiO₂. According to another preferred embodiment, the oxide phase of the first molybdenum disilicide based material comprises mullite, preferably in an amount of at least 60% by volume of the oxide phase, and a clay selected from the montmorillonite group, preferably bentonite. It has been found that utilizing an oxide phase comprising mullite as the main component increases the bubble temperature of the element, i.e. the temperature at which bubbles are formed on the surface of the element. The bubble temperature is a limiting factor when the element is to be used at high temperatures, such as 1200° C. and above.

However, the sintering is more difficult when the oxide phase is based on mullite. Therefore, it is preferable to make an addition of a clay, such as bentonite, which will improve the sinterability of the material.

At least a portion of at least one of the terminals of the heating element according to the present invention are made of a second molybdenum disilicide based material, said second material comprising up to 25% by volume of oxide phase. Examples of suitable molybdenum disilicide based materials fulfilling this criteria are materials used in heating elements sold under the under the trade names KANTHAL® SUPER 1700 and KANTHAL® SUPER 1800. According to a preferred embodiment of the heating element, said portion of a terminal is made of a molybdenum disilicide based material comprising 5-18% by volume oxide phase, preferably 10-18% by volume oxide phase.

The oxide phase of the second molybdenum disilicide based material is preferably clay or silica based or even essentially consisting of silica. However, a part of the silica may also optionally be substituted with Al₂O₃.

The fact that the heating zone and the terminals are made of different molybdenum disilicide based materials causes the heating element to have different resistivity in the different parts thereof. More specifically, the resistivity of the heating zone will be higher than the resistivity of the terminals. This leads to a reduced loss of power in the terminals compared to conventional heating elements of molybdenum disilicide materials and that a higher voltage can be used for the same element temperature and used power. Furthermore, the present invention enables usage of the same diameter of the heating zone and the terminals without any additional losses of power in the terminals. The terminals may in fact even be designed with a diameter which is smaller than the diameter of the heating zone employing the principles of the present invention.

According to one embodiment, the entire heating zone or heating zones are made of the first molybdenum disilicide based material and the entire terminals are made of the second molybdenum disilicide based material. According to a further embodiment of the present invention, the molybdenum disilicide based material in the heating zone of the heating element has a resistivity at a given temperature which is at least twice the resistivity of the molybdenum disilicide based material in the terminals. Preferably, the resistivity of the molybdenum disilicide based material in the heating zone is at least 2.5 times the resistivity of the molybdenum disilicide based material in the terminals.

The molybdenum disilicide based materials may be produced in accordance with previously known methods. One example of a suitable method is to mix finely divided molybdenum disilicide with finely divided oxide based material. The mixture is optionally pre-sintered in a non-oxidizing atmosphere at about 1000-1400° C. to produce a pre-sintered porous material. The final sintering is thereafter suitably conducted in an atmosphere free of excess oxygen at a temperature of approximately 1400-1700° C. It will be apparent to the skilled person that the content of oxide phase in the material produced may be controlled by altering the amount of oxide based material mixed with the molybdenum disilicide.

The heating element according to the present disclosure may be manufactured by producing the heating zone, or the heating zones, and the terminals separately. The terminals are thereafter welded to the heating zone by means of conventional methods, for example fusion welding under inert gas atmosphere.

According to an alternative embodiment of the invention, the heating element comprises more than one heating zone wherein each heating zone is separated from the adjacent heating zone by a terminal connection. The terminal connection is adapted to extend to the outside of the furnace through the furnace wall and to be electrically connected on the outside of the furnace.

According to yet another alternative embodiment of the invention, the heating element has a heating zone which is divided into a plurality of heating zone sections. At least one of the heating zone sections is made of the first molybdenum disilicide based material, i.e. a molybdenum disilicide based material comprising 48-75% by volume of oxide phase. The other section or sections of the heating zone may be made of the same molybdenum disilicide based material or of a different molybdenum disilicide based material, for example a third molybdenum disilicide based material with an oxide phase content different from both the first and second molybdenum disilicide based material. One example of such a heating element is shown in FIG. 2.

The heating element 1 in FIG. 2 is a U-shaped two shank heating element 1 comprising a heating zone consisting of a plurality of heating zone sections 3a, 4, 3b connected to each other in their respective ends. The sections 3a and 3b constitutes essentially straight rods, said rods being connected to each other via a bent section 4. In the ends of the sections 3a, 3b opposite to the ends connected to the bent section 4, the terminals 2 of the heating element are provided. At least one of the sections 3a, 3b, preferably both, are made of a first molybdenum disilicide based material comprising 48-75% by volume of oxide phase. The bent section 4 may be made of a molybdenum disilicide based material having a high oxide phase content, such as 48-75% by volume, but may also be made of a standard molybdenum disilicide based material, such as the molybdenum disilicide based material of the terminals.

It should be noted that the element can have any geometrical shape suitable for the intended application. The heating element may for example be a four shank element 5 as shown in FIG. 3. The heating element may also be a helically shaped element, i.e. having a heating zone 6 which is helically shaped as shown in FIG. 4. The terminals of the heating element are however not shown in FIG. 4. The heating element may also be a straight rod or wire, which constitutes the heating zone, and having terminals provided in each end of the rod or wire. The cross section of the rod may typically be circular, but may depending on the application have other geometrical shapes, elliptical or rectangular, for example.

The heating zone may comprise a plurality of heating zone sections wherein each section is made of a material with different oxide phase content. Thereby, a designed resistance profile, and hence a corresponding heat emitting profile, is provided along the heating zone of the heating element.

One or more of the terminals may comprise a plurality of terminal sections wherein at least one of the terminal sections is made of the second molybdenum disilicide based material and at least another of the terminal sections is made of the first molybdenum disilicide based material or of a molybdenum disilicide based material comprising an oxide content which is less than that of the first but higher than that of the second molybdenum disilicide based material.

The heating element according to the present disclosure may also comprise intermediate sections located between the heating zone and the terminals of the element. Such intermediate sections could be made of a third molybdenum disilicide based material, preferably having an oxide phase content which is between the oxide phase content of the first and second molybdenum disilicide based material. According to an embodiment, the oxide phase content of such an intermediate section changes gradually such that the oxide phase content in the part of the intermediate section which is in the vicinity of the heating zone is the same or close to the oxide phase content of the heating zone material, and the part of the intermediate section which is in the vicinity of the terminals is the same or close to the oxide phase content of the terminal material. This will enable a gradual change of the electric resistivity over the intermediate section.

### Theoretical Calculations

Theoretical calculations were made using the Stefan-Boltzmann law, shown in Equation 1 below wherein Cₛ is the Stefan-Boltzmann constant, ε is the emissivity, Tₑ is the element temperature and T_{f} is the furnace temperature.

p=Cₛε(Tₑ⁴−T_{f}⁴) Eq. 1

The surface load p in the heating zone was calculated using Equation 2, wherein P is the installed power and Aₑₜₒₜ is the total surface area of the heating zone of the element.

$$p = \frac{P}{{A}_{etot}} \qquad Eq . 2$$

The calculations were all made for a furnace temperature of 1400° C. and a temperature outside of the furnace of 25° C. The emissivity ε was set to 0.7, which essentially corresponds to the normal emissivity of molybdenum disilicide based materials used for heating elements.

All calculations were made for a two-shank element 1 as illustrated in FIG. 1. The element has a heating zone diameter d of 6 mm, a terminal diameter D of 12 mm, heating zone length Lₑ of 500 mm, a terminal length Lᵤ of 500 mm and a shank distance a of 60 mm.

By varying the resistivity factor of the heating zone relative to the resistivity of the terminals, the temperature of the heating element can be calculated as well as the minimum temperature of the terminals inside and outside of the furnace. As can be seen from Table 1, calculations were made for cases where the heating zone has a resistivity which is equal to the resistivity of the terminals as well as for cases were the resistivity is 2, 2, 5, 4, 5 and 10 times as high for the hot zone compared to the terminals.

The results of the theoretical calculations are shown in Table 1. The results show that the minimum terminal temperature outside of the furnace is substantially reduced with increasing resistivity of the heating zone. Moreover, it is clear from the calculations that the voltage used can be increased from about 18 V, for an element having the same resistivity in the terminals as in the heating zone, to about 57 V for a heating element having 10 times as high resistivity in the heating zone as in the terminals, while maintaining essentially the same power and element temperature.

TABLE 1

| | Case 1 | Case 2 | Case 3 | Case 4 | Case 5 | Case 6 |
|---|---|---|---|---|---|---|
| Electrical data | | | | | | |
| Current [A] | 136 | 96 | 86 | 68 | 61 | 43 |
| Resistivity | 1 | 2 | 2.5 | 4 | 5 | 10 |
| multiplication | | | | | | |
| factor, hot zone | | | | | | |
| Resistivity | 1 | 1 | 1 | 1 | 1 | 1 |
| multiplication | | | | | | |
| factor, terminals | | | | | | |
| Hot resistance, | 0.13 | 0.26 | 0.33 | 0.53 | 0.66 | 1.32 |
| whole element | | | | | | |
| [Ω] | | | | | | |
| Voltage [V] | 17.9 | 25.4 | 28.3 | 35.8 | 40.1 | 56.7 |
| Power [W] | 2438 | 2440 | 2437 | 2438 | 2436 | 2437 |
| Surface load | 11.025 | 11.034 | 11.022 | 11.025 | 11.017 | 11.022 |
| [W/cm²] | | | | | | |
| Calculated data | | | | | | |
| Element | 1531.9 | 1532.0 | 1531.8 | 1531.9 | 1531.8 | 1531.8 |
| temperature [° C.] | | | | | | |
| Minimum | 1416.8 | 1408.4 | 1406.7 | 1404.2 | 1403.4 | 1401.7 |
| terminal | | | | | | |
| temperature | | | | | | |
| inside furnace | | | | | | |
| [° C.] | | | | | | |
| Minimum | 237.1 | 149.1 | 128.1 | 93.7 | 81.2 | 54.6 |
| terminal | | | | | | |
| temperature | | | | | | |
| outside furnace | | | | | | |
| [° C.] | | | | | | |

### Resistivity Test

The resistivity was determined for a plurality of samples of molybdenum disilicide based materials to be used in the heating zone of a heating element according to the invention. The samples were produced in accordance with conventional methods for producing molybdenum disilicide based materials. The raw materials used for producing the samples are given in Table 3. The amount of molybdenum disilicide phase and the amount of oxide phase and porosity is also given in Table 3, as well as the theoretical density and density achieved after sintering.

Table 2 specifies the approximate composition of the two different kaolinite clays and the two different bentonite clays used. It should however be noted that the clays comprises additional elements in small amounts.

The resistivity was determined by measuring the resistance at room temperature of a rod of the samples specified in Table 3 and calculating the resistivity using the formula resistivity=resistance*area/length. The results are also shown in Table 3.

TABLE 2

| Composition | Kaolinite 1 | Kaolinite 2 | Bentonite 1 | Bentonite 2 |
|---|---|---|---|---|
| SiO₂ [wt-%] | Bal. | Bal. | Bal. | Bal. |
| Al₂O₃ [wt-%] | 31.6 | 35.2 | 21 | 15 |
| CaO [wt-%] | 0.024 | 0.04 | 1.7 | 1.9 |
| MgO [wt-%] | 0.21 | 0.25 | 2.8 | 3.0 |
| Fe₂O₃ [wt-%] | 0.77 | 0.75 | 4.4 | 0.8 |
| Na₂O [wt-%] | 0.26 | 0.16 | 2.5 | 0.5 |
| K₂O [wt-%] | 4.0 | 1.5 | | 0.14 |
| P₂O₅ [wt-%] | 0.12 | 0.3 | | |

TABLE 3

| Sample | 1 | 2 | 3 | 4 | 5 | 6 | 7 | 8 |
|---|---|---|---|---|---|---|---|---|
| MoSi₂ [g] | 880 | 1000 | 1200 | 1200 | 1400 | 1400 | 700 | 1200 |
| Kaolinite 1 [g] | 988 | 960 | — | — | — | — | — | — |
| Kaolinite 2 [g] | — | — | 800 | 400 | 600 | — | — | 400 |
| Al₂O₃ [g] | — | — | — | 400 | — | — | — | 400 |
| Mullite [g] | — | — | — | — | — | 600 | 250 | |
| Bentonite 1 [g] | 132 | 150 | — | — | — | — | — | |
| Bentonite 2 [g] | — | — | — | — | — | — | 50 | |
| Natrosol [g] | — | — | 5 | 5 | 5 | — | — | 5 |
| MoSi₂ [vol-%] | 24.6 | 26 | 32.9 | 31.2 | 43.5 | 36.8 | 45.8 | 27.2 |
| oxide/porosity | 75.4 | 74 | 67.1 | 68.8 | 56.5 | 57.1/6.1 | 54.2 | 72.8 |
| [vol-%] | | | | | | | | |
| Theroretical | 3.56 | 3.65 | 4.07 | 4.53 | 4.46 | 4.83 | 4.67 | 4.53 |
| density | | | | | | | | |
| Density | 3.4 | 3.54 | 3.9 | 4.12 | 4.34 | 3.45 | 4.75 | 4.05 |
| Resistivity at | 227 | 20 | 22.7 | 18.7 | 2.34 | 1.8 | 0.83 | 35.2 |
| RT [Ωmm²/m] | | | | | | | | |

The results shown in Table 3 can for example be compared to a resistivity of approximately 0.3 Ωmm²/m of a conventional molybdenum disilicide based material use in heating elements sold under the trade name Kanthal® Super 1700.

The resistivity of sample 1 which comprised 75.4% by volume of oxide phase is so high that it is unsuitable to be used in a heating element. In fact, it is so high that it for this application can be considered as an isolator. However, in the case of sample 2, which comprises only slightly less oxide phase than sample 1, the resistivity is sufficiently low for the material to conduct a current. Furthermore, sample 8 which has a high content of oxide phase shows a high resistivity but is still conductive. These results show that a molybdenum disilicide based material to be utilized as a heater should not comprise more than 75% by volume of oxide phase.

Essentially the same amount of oxide phase was used as raw materials for samples 3 and 4, but with the difference that in sample 4 half of the kaoline clay was substituted with Al₂O₃. After sintering, sample 4 comprised a higher content of oxide phase than sample 3. Sample 3 showed a higher resistivity than sample 4.

The results of samples 2, 3, 4 and 8 indicates that it is possible to achieve a resistivity in the order of about 20 Ωmm²/m for a molybdenum disilicide based material comprising about 70% oxide phase.

Sample 5 comprises a higher amount of silicide phase than samples 2-4 and showed an increase of the bubble temperature to approximately 1600° C. This can be compared to samples 3 and 4 which showed a bubble temperature of approximately 1480° C. and 1440° C., respectively. Moreover, sample 5 still has a much higher resistivity than the conventional molybdenum disilicide based material mentioned above.

Samples 4 and 8 were produced from the same raw materials and in the same amounts, however sample 8 was sintered to a higher density than sample 4. Samples 4 and 8 showed the same resistivity. The measured density of sample 7 is higher than the theoretical density.

The reason for this is believed to be a mistake in the temperature and atmosphere during sintering of the sample such that a part of the silicon from the MoSi₂ phase was evaporated leading to formation of Mo₅Si₃ phase. The Mo₅Si₃ phase has a higher density than the MoSi₂ phase. It is however believed that sample 7, which comprises both mullite and bentonite, is possible to sinter to essentially full density.

Sample 7 showed the lowest resistivity of the tested samples and had the lowest oxide phase content of the tested materials. The resistivity is however still more than twice the resistivity of the conventional molybdenum disilicide based material mentioned above.

1. Heating element comprising at least one heating zone and at least two terminals, wherein at least a portion of the heating zone is made of a first molybdenum disilicide based material, said first molybdenum disilicide based material comprising 48-75% by volume of a non-conducting compound, and wherein at least a portion of one of the terminals is made of a second molybdenum disilicide based material, said second molybdenum disilicide based material comprising up to 25% by volume of a non-conducting compound.

2. The heating element according to claim 1, wherein said non-conducting compound of the first molybdenum disilicide based material is SiO₂-based, Al₂O₃-based or a mixture comprising essentially SiO₂ and Al₂O₃.

3. The heating element according to claim 1, wherein said non-conducting compound of the second molybdenum disilicide based material is SiO₂-based, Al₂O₃-based or a mixture comprising essentially SiO₂ and Al₂O₃.

4. The heating element according to claim 1, wherein the first molybdenum disilicide material comprises 50-68% by volume of non-conducting compound.

5. The heating element according to claim 1, wherein the second molybdenum disilicide material comprises 5-18% by volume of non-conducting compound.

6. The heating element according to claim 1, wherein the heating zone comprises a plurality of heating zone sections wherein at least one of the heating zone sections is made of said first molybdenum disilicide based material and that at least another section of the heating zone is made of a molybdenum disilicide based material comprising a lower content of non-conducting compound.

7. The heating element according to claim 1, wherein it further comprises an intermediate part located between the heating zone and the terminal and wherein said intermediate part is made of a third molybdenum disilicide material having a non-conducting compound content which is lower than the oxide content of the heating zone but higher than the non-conducting compound content of the terminal.

8. The heating element according to claim 1, wherein the non-conducting compounds are based on mullite.

9. The heating element according to any of the claim 1, wherein the non-conducting compounds comprises mullite and a clay selected from the montmorillonite group.

10. The heating element according to claim 1, wherein the non-conducting compound comprises at least 60% by volume of mullite.

11. The heating element according to claim 4, wherein the first molybdenum disilicide material comprises 52-63% by volume of non-conducting compound.

12. The heating element according to claim 5, wherein the second molybdenum disilicide material comprises 10-18% by volume of non-conducting compound.

13. The heating element according to claim 9, wherein the clay is bentonite.
